(19) United States
(12) Patent Application Publication
(10) Pub. No.: US 2021/0085050 A1
(43) Pub. Date: Mar. 25, 2021

(54) HANDLE FOR USE WHEN PULLING WHEELED CONTAINERS

(71) Applicant: Desmond Travers, LLC, Canton, OH (US)

(72) Inventor: Michael A. Hinnebusch, SR., Canton, OH (US)

(73) Assignee: Desmond Travers, LLC, Canton, OH (US)

(21) Appl. No.: 17/025,517

(22) Filed: Sep. 18, 2020

Related U.S. Application Data
(60) Provisional application No. 62/902,987, filed on Sep. 20, 2019.

(51) Int. Cl. A45C 13/26; B62B 5/06; A45C 5/14

(52) U.S. Cl. CPC A45C 13/262; A45C 2013/267; A45C 5/14; B62B 5/06

(57) ABSTRACT

The present disclosure relates generally to a handle and method for use when pulling wheeled containers. The handle includes two sections including a first portion and a second portion. The second portion is selectively movable in order to accommodate a handle from a wheeled container.

### CROSS REFERENCE TO RELATED APPLICATIONS

This application claims the benefit of U.S. Provisional Patent Application 62/902,987 filed on Sep. 20, 2019; the disclosure of which is incorporated herein by reference.

### TECHNICAL FIELD

The present disclosure relates generally to a handle for use when pulling or pushing wheeled containers. More particularly, the present disclosure relates to a handle with a second portion that may close and be secured around handles of wheeled containers. Specifically, the present disclosure relates to a handle that may be gripped by a user and opened and closed about the second portion through manual manipulation.

### BACKGROUND

With air travel being ubiquitous, luggage with wheels has become very popular. However, lifting, lowering, pushing, pulling, carrying, holding and dragging heavy loads which involve static and dynamic efforts cause strain on various muscles and joints as well as wear and tear on the back. Travelers may experience pain caused by overuse strain, causing damage to tendons around the shoulder, elbow, wrist and other joints. Travelers may benefit from an ergonomic handle for spinner and roller luggage to reduce stress and strain maneuvering luggage during travel, and also reduce tripping and toppling of luggage.

Retractable handles on luggage have helped, but many times are too finicky. Broken handles account for nearly 90% of warranty claims for wheeled luggage. Much of this is due to the fact that the locking mechanism used to secure the handle in its extended position is often made of inferior materials and tends to degrade overtime when a transverse force is applied on it for extended periods of time. Most of this time is spent dragging the bag through whatever airport or hotel lobby to which a traveler is traveling.

Many of these handles integrated with conventional luggage are only extendable in one direction and remains stationary, rigid, and offer little freedom when gripping and subsequently pulling or pushing. These reduced degrees of freedom causing handle restrictions will fatigue and discomfort users when they transport their luggage.

### SUMMARY

Therefore, handles may benefit from improvement. Exemplary embodiments herein are directed to a handle for pushing or pulling for either left or right handed individuals.

In one aspect, an exemplary embodiment of the present disclosure may provide an apparatus for transporting objects comprising: a first portion including a handle; and a second portion with a body that is operatively connected to the handle and adapted to be engaged with a handle of a wheeled device. This exemplary embodiment or another exemplary embodiment may further provide an inner perimeter of the second portion and an outer perimeter of the second portion; and a retractable locking mechanism on the second portion. This exemplary embodiment or another exemplary embodiment may further provide the locking mechanism comprises: plurality of teeth and a plurality of recesses located on an outer perimeter of the second portion. This exemplary embodiment or another exemplary embodiment may further provide a stop located on the inner perimeter. This exemplary embodiment or another exemplary embodiment may further provide a sawtooth catch located on the inner perimeter. This exemplary embodiment or another exemplary embodiment may further provide the stop and the sawtooth catch on the inner perimeter are operative to interface with the plurality of teeth and the plurality of recesses on the outer perimeter. This exemplary embodiment or another exemplary embodiment may further provide a first post on the outer perimeter. This exemplary embodiment or another exemplary embodiment may further provide the first post has a reinforcement region. This exemplary embodiment or another exemplary embodiment may further provide a second post on the outer perimeter. This exemplary embodiment or another exemplary embodiment may further provide a gap located between a first side and a second side of the second portion that has a first distance when unengaged with the handle, a second distance greater than the first distance when engaging with the handle of the wheeled device. This exemplary embodiment or another exemplary embodiment may further provide the gap does not exist when the apparatus is engaged with the handle of the wheeled device. This exemplary embodiment or another exemplary embodiment may further provide the second portion is made of a resilient material capable of being deformed.

In another aspect, an exemplary embodiment of the present disclosure may provide a method of moving a wheeled device comprising: opening a second portion of an apparatus to create a gap large enough to accommodate a handle of the wheeled device; placing the handle of the wheeled device within an interior of the second portion; closing the second portion beyond an original position prior to opening the second portion of the apparatus; securing the second portion to the handle of the wheeled device; and initiating movement of the wheeled device through manipulation of a handle operatively connected to the second portion. This exemplary embodiment or another exemplary embodiment may further provide the opening step comprises: manipulating at least one post located on an outer perimeter of the second portion to cause a gap located at the outer perimeter to increase in size. This exemplary embodiment or another exemplary embodiment may further provide manipulating at least one post located on an outer perimeter of the second portion to eliminate a gap. This exemplary embodiment or another exemplary embodiment may further provide after placing: operating a locking mechanism located on the second portion. This exemplary embodiment or another exemplary embodiment may further provide after placing: engaging a saw tooth catch located on an inner perimeter of the second portion. This exemplary embodiment or another exemplary embodiment may further provide engaging at least one of a plurality of teeth and at least one plurality of recesses located on the outer perimeter of the second portion with a stop located on an inner portion of the second portion; pushing a second stop towards a first stop to engage the locking mechanism; and pulling the second stop away from the first stop to disengage the locking mechanism. This exemplary embodiment or another exemplary embodiment may further provide simultaneous to securing: contacting a portion of an inner perimeter of the second portion with at least a portion of the handle of the wheeled device. This exemplary embodiment or another exemplary embodiment may further provide the initiating movement step comprises: pulling via the handle operatively connected to the second portion at an angle operative to reduce strain and be comfortable to a hand of a user.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a front right perspective view of an exemplary handle apparatus.

FIG. 2 is a cross sectional view of the exemplary handle taken along line 2-2 in FIG. 1.

FIG. 3 is a side view focusing on a second portion of the exemplary handle.

FIG. 4A is an operational view of the second portion of the exemplary handle accommodating a luggage handle.

FIG. 4B is an operational view of the second portion of the exemplary handle around the luggage handle.

FIG. 4C is an operational view of the second potion of the exemplary handle secured to the luggage handle.

FIG. 5 is an operational view of the exemplary handle attached to a piece of luggage with a user manipulating the handle.

FIG. 6 is a further operational view of an alternative use for the exemplary handle.

Similar numbers refer to similar parts throughout the drawings.

### DETAILED DESCRIPTION

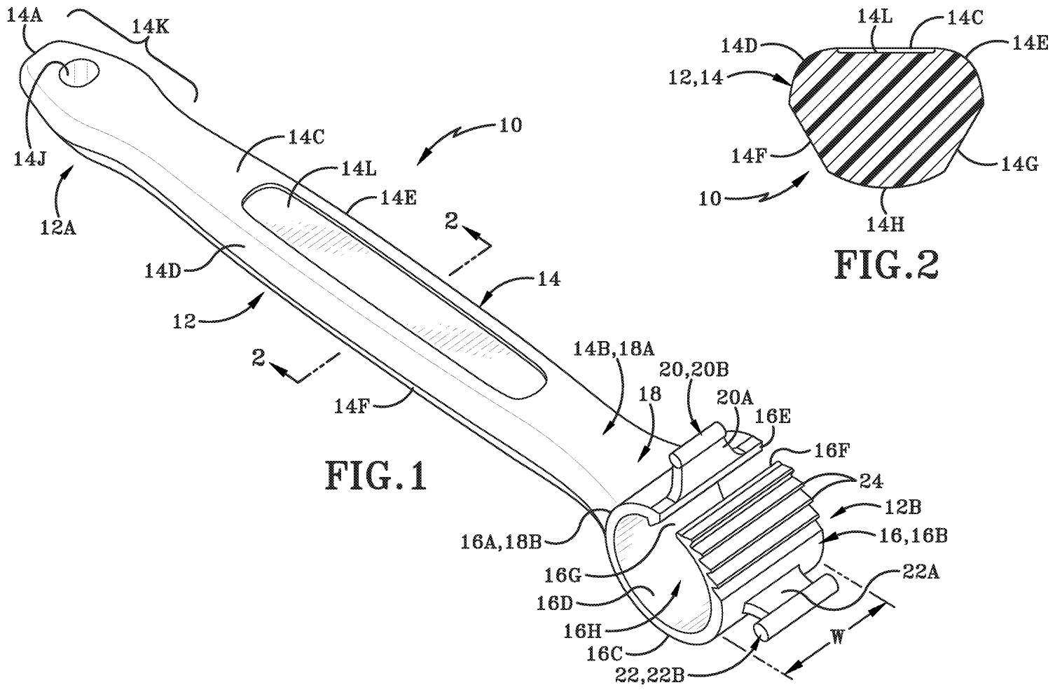

A new handle 10 and method of operation thereof is depicted in the present disclosure and throughout FIGS. 1-5. Handle 10 is a new and improved apparatus, as will be discussed hereafter.

Referring specifically to FIG. 1 and FIG. 2, the handle 10 is shown. The handle 10 has a body 12 with a handle portion or first portion 14 at a first end 12A and a clasp portion or second portion 16 at a second end 12B. The handle portion 14 has a first end 14A and a second end 14B laterally opposed thereto. In an exemplary embodiment the handle may be made of flexible to rigid plastic. Examples include, but are not limited to polyethylene, polypropylene, polyvinyl chloride, acrylonitrile-butadiene-styrene copolymer (ABS), silicones and other silicon-containing polymers, and polycarbonate.

Referring specifically to FIG. 2, a cross section of the handle 10 along line 2-2 of FIG. 1 is shown. The handle portion 14 is generally ergonomically beveled with six distinct faces so as to be grasped by a user. The handle portion has a first face 14C that is generally flat connected to a second face 14D and a third face 14E. The second face 14D and third face 14E are both arc shaped and are mirror images of one another and have the same arc length. Connected to the second face 14D is a fourth face 14F that is linear in nature, while the third face 14E is connected to a fifth face 14G that is also linear in nature. Each the fourth face 14F and fifth face 14G are the same distance. The fourth face 14F and fifth face 14G are connected by an arced sixth face 14H. Proximate the first end 14A is an aperture 14J on a bulbous portion 14K of the first end 14A. The aperture 14J goes through the first face 14C and the sixth face 14H. Further located on the first face 14C is a depression 14L region. In an exemplary embodiment, the depression region 14L may include identifying indicia such as a logo or luggage tag, or other such identifying material. While the exemplary embodiment is shown to be of a design with six faces, alternative embodiments are contemplated with different configurations while remaining ergonomically shaped to contour and be comfortable in a hand of a user. Though not shown in this embodiment the handle 10 may be outfitted with a soft grip surface allows a user to be far more comfortable as well.

The handle 10 further includes a transition region 18 which transitions the handle portion 14 to the second portion 16. The transition region 18 has a first end 18A proximate the second end 14B of the handle portion and a second end 18B proximate a fixed end 16A of the second portion 16.

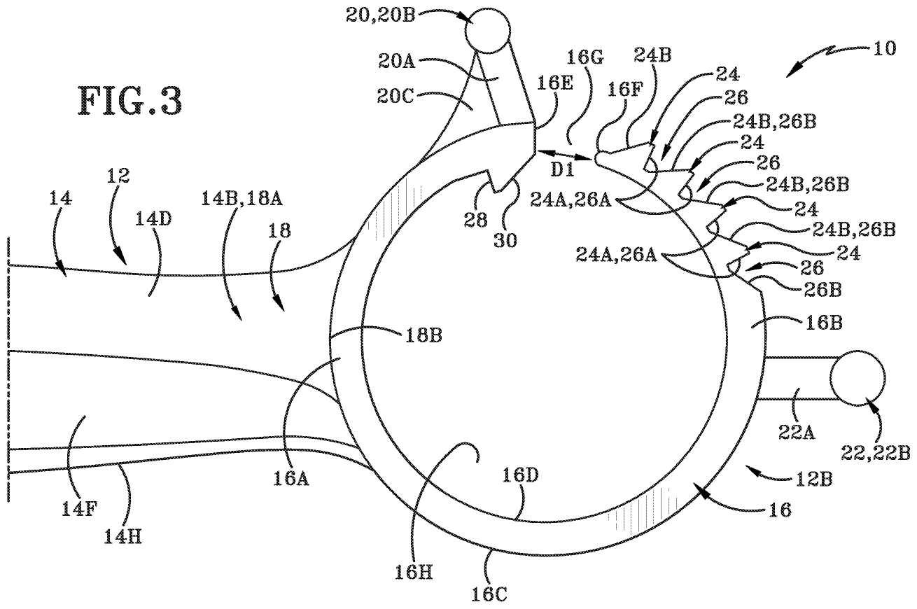

Referring specifically to FIG. 1 and FIG. 3, the second portion 16 further includes an adjustable end 16B laterally opposite the fixed end 16A. The second portion 16 has a body that is generally hollow cylindrical in nature with the exception of the features of the second portion 16 as will be discussed herein. The second portion 16 further includes an outer perimeter 16C and an inner perimeter 16D opposed thereto. Both the outer perimeter 16C and inner perimeter 16D have a width “W”. The second portion further includes a first end 16E and a second end 16F with a gap 16G therebetween. The gap 16G has a distance D1 in its resting position. The second potion 16 also includes a handle receiving area 16H. Proximate the first end 16E and on the outer perimeter 16C is a first post 20. The first post 20 has a tapered rod region 20A and a bulbous region 20B that is above the tapered rod region 20A. The first post 20 further includes a reinforcement region 20C laterally towards the fixed end 16A of the second portion. Further on the outer perimeter 16C is a second post 22 proximate the adjustable end 16B. The second post 22 includes a tapered rod region 22A and a bulbous region 22B that is above the tapered rod region 22A. Looking at FIG. 3 like an analog clock, the first post 20 is located around 11:30 while the second post 22 is located around 3:00.

The outer perimeter 16C further includes a locking mechanism that comprises a plurality of teeth 24 and recesses 26 formed within the outer perimeter 16C. The teeth 24 may also be referred to as sawtooth or sawteeth. The plurality of teeth 24 are generally right triangle shaped with a first leg 24A and hypotenuse 24B formed with the recesses 26A leg and 26B hypotenuse, respectively. While the plurality of teeth 24 and the recesses 26 are shown to be generally right triangle shaped, other shapes are contemplated in alternative embodiments such as squares, other triangles, or other engagable shapes.

Further included on the inner perimeter 16D is a stop 28. The stop 28 is located almost below the first post 20. The stop 28 is at a right angle with respect to the inner perimeter 16D. Angled above the stop 28 is an angled surface 30. The angled surface may further be referred to as a sawtooth catch 30. While the stop 28 and the angled surface 30 are shown to //be of a particular shape in the exemplary embodiment, other embodiments may differ in shape to interface with the plurality of teeth 24 and plurality of recesses 26 of different shapes as discussed earlier.

Having thus described an exemplary non-limiting configuration of the handle 10, its operation will be discussed with reference to some exemplary features used with the handle 10. Therefore, references to a particular embodiment below are understood to include all similarly featured embodiments, whether specifically recited or not, unless explicitly stated otherwise.

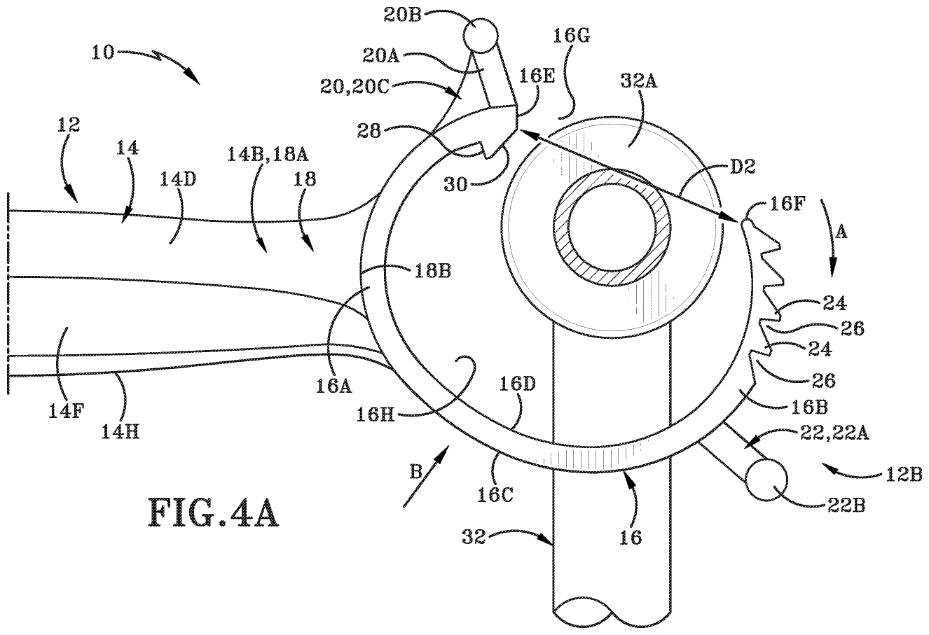

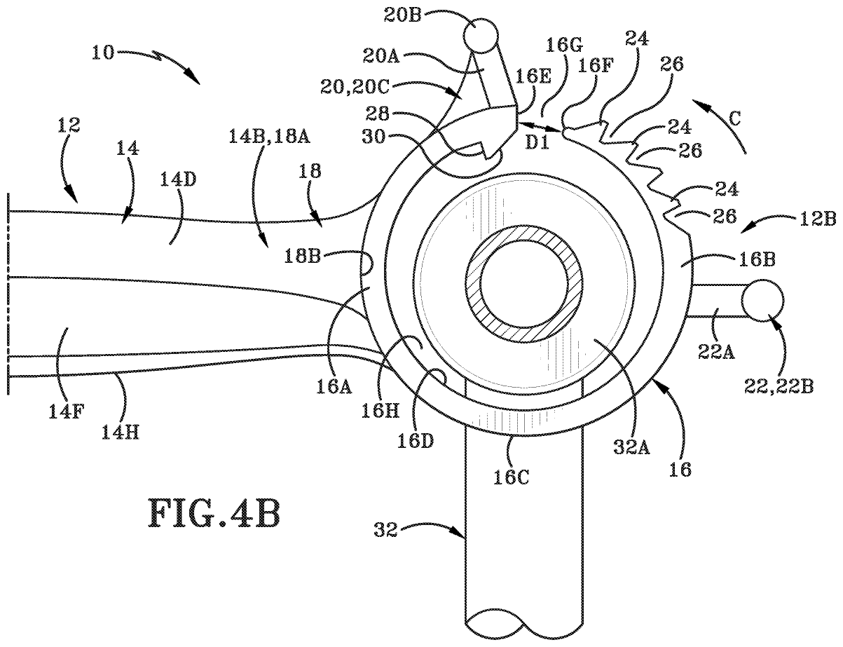

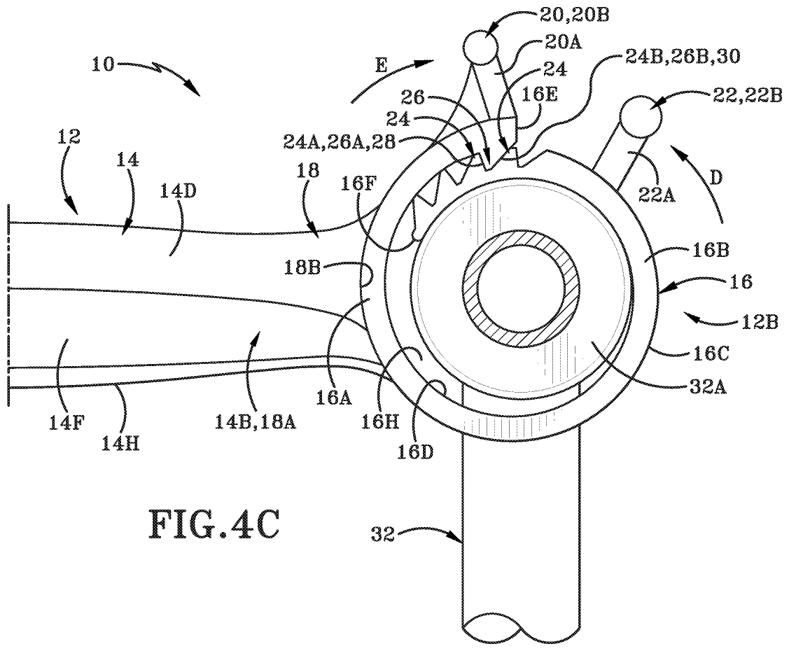

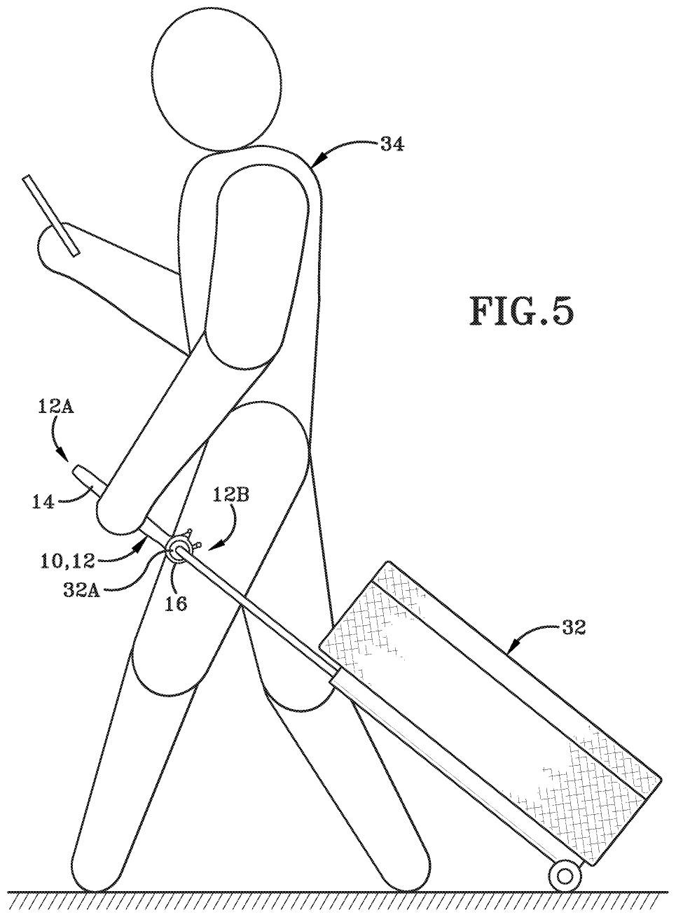

Referring now to FIG. 4A, the exemplary handle 10 is in the process of being attached to a suitcase 32 with a handle 32A. Although described herein as a “luggage” or “an article of luggage,” it will be understood that the handle 10 described herein may operationally attach to other objects according to a user's desired application. It will be further understood that the item to which the transport devices attach need not be limited by the examples provided herein. The exemplary handle 10 may be begun to be attached by moving the post 22 in the direction of arrow “A”.

As a result of moving the post 22 in the direction “A” the body of the second portion 16 is deformed from its cylindrical shape to an approximate oval shape. The movement of the post in the direction about arrow “A” also creates a larger gap 16G with a distance D2. This distance D2 is sufficient to accommodate the handle 32A of the suitcase 32 and the handle 10 is moved in a direction about arrow “B” to begin to wrap around the handle 32A.

Referring specifically to FIG. 4B, the exemplary handle 10 has been placed around the handle 32A of the suitcase 32 but not yet secured. The post 22 has been moved in the direction along arrow “C” thereby returning the second portion to its resting position as shown in FIGS. 1 and 3 with a gap 16G distance of D1. While in the exemplary embodiment the post 22 is moved, the second portion 16 may be made of a resilient material in order to collapse back to the distance of D1 without kinetic intervention from a user.

Continuing on to FIG. 4C, the exemplary handle 10 has been secured to the handle 32A of the suitcase 32 the second end 16F is pushed in the direction of arrow “D” via the post 22. This eliminates the gap 16G and begins to engage at least one of the plurality of teeth 24. Specifically, the hypotenuse side 24B, 26B of the teeth abuts against the angled portion 30. This continues until the angled portion 30 terminates which causes the leg portion 24A, 26A to be in contact with the stop 28. As a result, movement is restricted from disengaging the teeth 24 and recesses 26 from the stop and the handle 10 at its second portion 16 is engaged with the handle 32A of the luggage 32. Depending on the size of the handle 32A and diameter of the second portion 16, additional teeth 24 and recesses 26 may need to be engaged by a user to create a firm grasp of the inner perimeter 16D of the second portion. The new shape of the second portion is reminiscent of an ouroboros with the gap 16G eliminated and the second end 16F past the first end 16E. The plurality of teeth 24 with the plurality of recesses 26, the stop 28 and the angled surface 30 operate as a ratchet type mechanism in order to removably secure the second portion 16 to the luggage handle 32.

Additionally, a user may move both in the direction “D” as well as creating leverage by expending force on the post 20 shown about arrow “E”. In this manner, a user may more precisely and more easily overcome the force of the teeth 24 on the stop 28 and angled portion 30 and ratchet the second portion 16 into contact with the handle 32A of the luggage 32 in a faster manner. Manipulation can occur at either post with respect to engagement or disengagement. Specifically, the post 20 can be manipulated in an upward manner to disengage the angled surface 28 from the leg 24A, 26A of the teeth and recess, respectively. The second post 22 can be manipulated in a downward manner that can cause disengagement of the angled surface 28 from the leg 24A, 26A of the teeth and recess, respectively.

Specifically, in one embodiment a user may open the locking mechanism on the second portion 16 of the handle 10 in order to create the gap 16G large enough to accommodate the handle 30A of the wheeled device 30. This is accomplished by manipulating at least one of the posts 20, 22 on the outer perimeter 16C of the second portion 16. In the exemplary embodiment, the post 22 is pulled in a direction away from the first end 16E. Then, a user can place the handle 30 of the wheeled device 30A within the interior 16F of the second portion 16. A user may then close the second portion 16 beyond the original position prior to opening the second portion 16 of the apparatus and eliminating the gap 16G. This is done by manipulating at least one post 20, 22 towards the first end 16E. A saw tooth catch or angled surface 28 engages the leg 24A, 26A of the teeth and recesses. This then secures the second portion 16 to the handle 32A of the wheeled device 32. The catch 28 may then be disengaged by pulling the post 22 away from the first side 16E. At least a portion of the inner perimeter 16D is in contact with the handle 32A of the wheeled device 32.

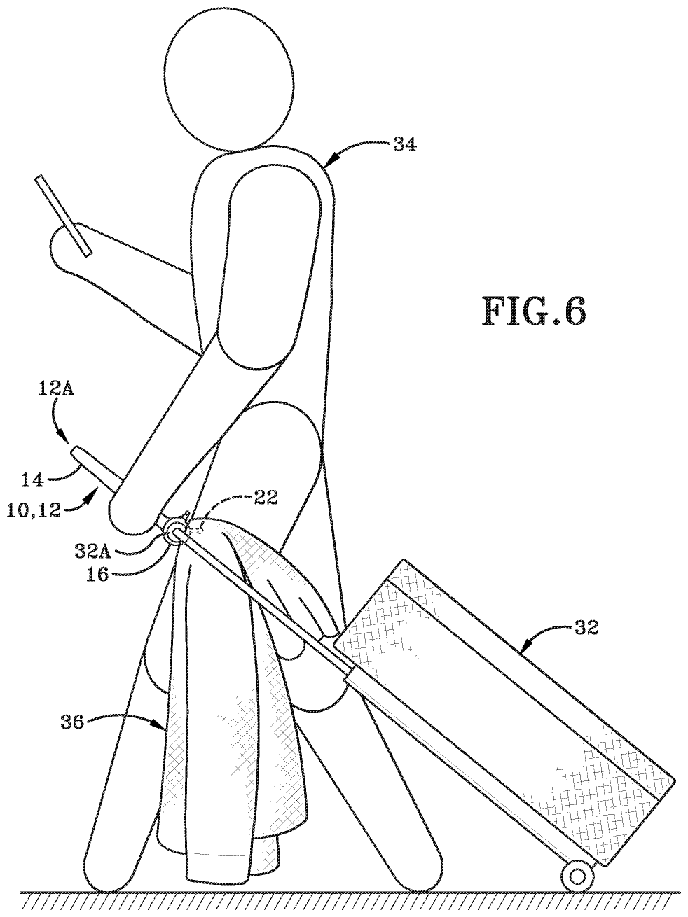

Referring to FIG. 5, a user 34 is able to manipulate the handle 10 to move the luggage 32. As a result of the prior steps, the suitcase handle 32A is fixedly held by the second portion 16 of the handle 10 and a user 34 may grasp the first portion 12 and force may be applied to the luggage 32 through use of the handle 10. As a result, the luggage 32 may be moved by pulling or otherwise directed by the user 34 by the force applied to the handle 10.

As the handle 10 is attached to the luggage 32 and may rotate about somewhat freely, the user 34 may pull at an angle different from a purely horizontal angle. The user 34 may pull at a more idea angle above horizontal, which is about 32 degrees. Such a grip will provide significantly less stress on the user's back. The user 34 may further freely rotate the handle 10 allowing to further adjust the angle and/or distance of the luggage 32 relative to the back and rear of the user to prevent interference or restriction of the user's gait.

When the luggage 32 has reached its desired destination, the user 34 may remove the handle 10. This would occur by disengaging the teeth 24 with the stop 28 and prying the section portion 16 into its oval configuration. The user 34 may accomplish this by grasping the first post 20 and the second post 22 and jostling them in opposite directions to disengage the teeth. The handle 10 may then be stored for later use. In one embodiment, when the handle 10 is not in use, the aperture 12J may be outfitted with a carabineer or other such gripping mechanism. In the alternative, in many attachments may be used such as string, twine, ribbon, zip ties or other such flexible and attaching means.

Referring specifically to FIG. 6, an alternative use for the handle 10 is shown. Specifically, handle 10 while engaged with the handle 32A of the suitcase 32 may be used as a coat rack. Specifically, the second post 22 while the locking mechanism is engaged is operative to act as a post that one may hang their jacket 36 onto. As a result, the handle 10 may serve a dual purpose including hanging a jacket 36 while walking long distances with the luggage 32 through airports, hotels, conventions and the like.

The handle 10, though talked about as a first portion 14 and second portion 16 may be a unibody that is integrally extruded, molded, printed, or additively manufactured, removably machined, or formed as a unitary, monolithic member substantially fabricated from a rigid yet flexible, manmade material. In one example, metal or metal alloys, such as stainless steel or aluminum alloy, may form a substantial majority of the components or elements used to fabricate the handle body 12 and the various components integrally formed, molded, or extruded therewith. The handle body 12 should withstand use by a user 34 using it to pull a piece of luggage without damaging the handle body 12. While it is contemplated that the handle body 12 and its additional components described herein are uniformly and integrally extruded, molded, or formed, it is entirely possible that the components of the handle body 12 be formed separately from alternative materials as one having routine skill in the art would understand. In another example, the handle body may be formed from an elastomeric material or rubber material configured to withstand deformation upon impact or stress by the user 34. Furthermore, while the components of the handle body 12 are discussed below individually, it is to be clearly understood that the components and their corresponding reference elements of the handle body 12 are portions, regions, or surfaces of the handle body 12 and all form a respective element or component of the unitary handle body 12. Thus, while the components may be discussed individually and identified relative to other elements or components of the handle body 12, in this exemplary embodiment, there is a single handle body 12 having the below described portions, regions, or surfaces.

It will be further understood that the configuration of all embodiments of the handle 10 may be utilized according to a user's 34 preference and/or the desired implementation thereof while remaining within the scope of the disclosure herein.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. An apparatus for transporting objects comprising:
a first portion including a handle; and
a second portion with a body that is operatively connected to the handle and adapted to be engaged with a handle of a wheeled device.

2. The apparatus of claim 1, further comprising:
an inner perimeter of the second portion and an outer perimeter of the second portion; and
a retractable locking mechanism on the second portion.

3. The apparatus of claim 2, wherein the locking mechanism comprises:
plurality of teeth and a plurality of recesses located on an outer perimeter of the second portion.

4. The apparatus of claim 3, further comprising:
a stop located on the inner perimeter.

5. The apparatus of claim 4, further comprising:
a sawtooth catch located on the inner perimeter.

6. The apparatus of claim 5, wherein the stop and the sawtooth catch on the inner perimeter are operative to interface with the plurality of teeth and the plurality of recesses on the outer perimeter.

7. The apparatus of claim 2, further comprising:
a first post on the outer perimeter.

8. The apparatus of claim 7, wherein the first post has a reinforcement region.

9. The apparatus of claim 7, further comprising:
a second post on the outer perimeter.

10. The apparatus of claim 1, further comprising:
a gap located between a first side and a second side of the second portion that has a first distance when unengaged with the handle, a second distance greater than the first distance when engaging with the handle of the wheeled device.

11. The apparatus of claim 10, wherein the gap does not exist when the apparatus is engaged with the handle of the wheeled device.

12. The apparatus of claim 1, wherein the second portion is made of a resilient material capable of being deformed.

13. A method of moving a wheeled device comprising:
opening a second portion of an apparatus to create a gap large enough to accommodate a handle of the wheeled device;
placing the handle of the wheeled device within an interior of the second portion;
closing the second portion beyond an original position prior to opening the second portion of the apparatus;
securing the second portion to the handle of the wheeled device; and
initiating movement of the wheeled device through manipulation of a handle operatively connected to the second portion.

14. The method of claim 13, wherein the opening step comprises:
manipulating at least one post located on an outer perimeter of the second portion to cause a gap located at the outer perimeter to increase in size.

15. The method of claim 13, wherein the securing step comprises:
manipulating at least one post located on an outer perimeter of the second portion to eliminate a gap.

16. The method of claim 13, further comprising:
after placing:
operating a locking mechanism located on the second portion.

17. The method of claim 13, further comprising:
after placing:
engaging a saw tooth catch located on an inner perimeter of the second portion.

18. The method of claim 16, further comprising:
engaging at least one of a plurality of teeth and at least one plurality of recesses located on the outer perimeter of the second portion with a stop located on an inner portion of the second portion;
pushing a second stop towards a first stop to engage the locking mechanism; and
pulling the second stop away from the first stop to disengage the locking mechanism.

19. The method of claim 15, further comprising:
simultaneous to securing:
contacting a portion of an inner perimeter of the second portion with at least a portion of the handle of the wheeled device.

20. The method of claim 15, wherein the initiating movement step comprises:
pulling via the handle operatively connected to the second portion at an angle operative to reduce strain and be comfortable to a hand of a user.
